(19) United States
(12) Patent Application Publication
(10) Pub. No.: US 2007/0277106 A1
(43) Pub. Date: Nov. 29, 2007

(54) Method and structure for managing electronic slides using a slide-reading program

(75) Inventors: Samer Takriti, Croton on Hudson, NY (US); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/441,239

(22) Filed: May 26, 2006

(51) Int. Cl. G06F 9/00

(52) U.S. Cl. 715/723; 715/732; 715/730; 715/731

(57) ABSTRACT

A method (and structure) of managing a software slide deck that includes a plurality of slides. Tag data is associated with one or more slides in the slide deck for purpose of processing at least one function related to managing the slide deck.

### BACKGROUND OF THE INVENTION

1. Field of the Invention

The present invention generally relates to software-based slide generation and presentation programs. More specifically, a tag format permits management of slides for purposes of organizing, re-organizing, sorting, and/or filtering.

2. Description of the Related Art

Software-based slide decks are useful in conveying ideas due to the succinctness of the presentation format. As a result, slide generation software programs such as PowerPoint are used not only for presentations but also for storing information in a concise and visual format.

However, the organization of those ideas is presently quite cumbersome due to a lack of an important feature and functionality. In particular, current software for slide generation does not permit easy organization of the slides themselves, or their content.

For example, when the number of slides in a deck, or multiple decks, becomes large, it would be a great advantage to be able to organize, sort, or filter the slides according to one or more different criteria.

Thus, a need exists for a mechanism that permits a user to manage electronic slides in accordance with a desired criterion that possibly changes over time, including scenarios of changes in slide order or availability that are desired as the presentation proceeds.

### SUMMARY OF THE INVENTION

In view of the foregoing, and other, exemplary problems, drawbacks, and disadvantages of the conventional systems, it is an exemplary feature of the present invention to provide a structure (and method) in which a system provides a mechanism for adding organization, sorting, and filtering features to electronic slide decks or sets of slide decks.

Therefore, in a first exemplary aspect, described herein is a method of managing a software slide deck including a plurality of slides, including associating tag data for one or more slides in the slide deck for processing at least one function related to managing the slide deck.

In a second exemplary aspect, also described herein is a system that provides this slide deck managing method.

In a third exemplary aspect, also described herein is a signal-bearing medium tangibly embodying a program of machine-readable instructions executable by a digital processing apparatus to perform this slide deck managing method.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows an exemplary design method 100 of the present invention;

FIG. 2 shows exemplarily the concept of tag data 200;

FIG. 3 shows an exemplary modification 300 of an existing software slide presentation program to add the tools 303 of the present invention;

FIG. 4 shows an exemplary block diagram 400 of a software program implementing the present invention;

FIG. 5 illustrates an exemplary hardware/information handling system 500 for incorporating the present invention therein; and

FIG. 6 illustrates a signal bearing medium 600 (e.g., storage medium) for storing steps of a program of a method according to the present invention.

### DETAILED DESCRIPTION OF AN EXEMPLARY EMBODIMENT OF THE INVENTION

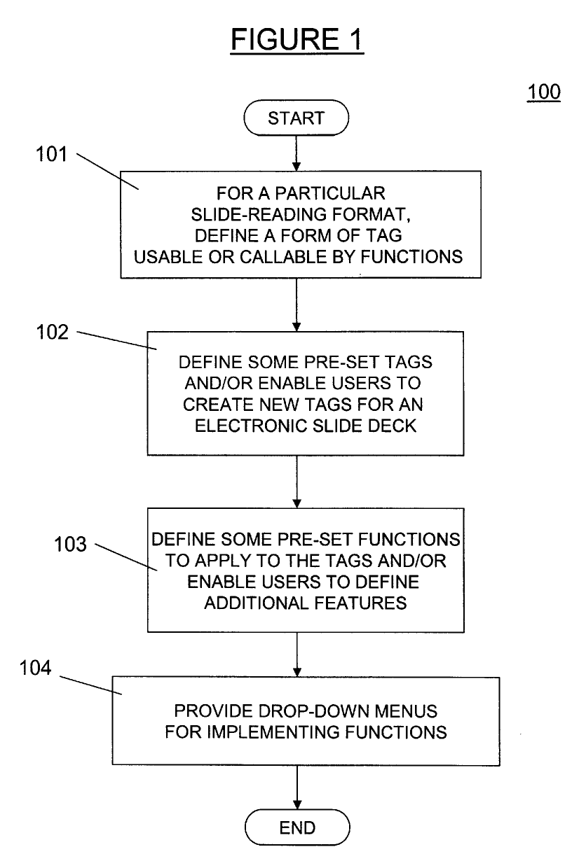

Referring now to the drawings, and more particularly to FIGS. 1-6, there are shown preferred embodiments of the method and structures according to the present invention.

The exemplary mechanism described herein for the present invention can be perhaps considered as an incorporation, into software slide generation/presentation programs, of features resembling those available in various data-intensive software programs.

For example, a spreadsheet software application might typically include features of use for tagging and macro generation. A database software application program might typically include features of use for query languages and semantic-language recognition. Typically, in any of these application programs, the most commonly needed of these features are implemented in a pull-down menu format.

The present invention teaches the incorporation of similar features to the environment of slide-reading software, such as, for example, Microsoft PowerPoint™, Adobe AcroRead™, OpenOffice™. Similar to the implementation of these features in other environments, the present invention also teaches that the most commonly needed of these features can be implemented in a pull-down menu format.

FIG. 1 shows exemplarily an implementation 100 of the concepts of the present invention into an existing slide-reading software, such as PowerPoint™. In step 101, the method of the present invention includes the basic concept of a tag that is usable or callable by functions for the software into which the mechanism is being incorporated. This “tag” concept might be applied to current data or format content in a slide, or it may represent a field associated with a slide in which the user manually enters new content solely for the sake of organizing, sorting or filtering the slides or such content is automatically derived from data already existing in the slide data. In this latter concept, the “tag” concept could be viewed as equivalent to the capability to extract and/or simply evaluate the information within the data or format fields of the slides.

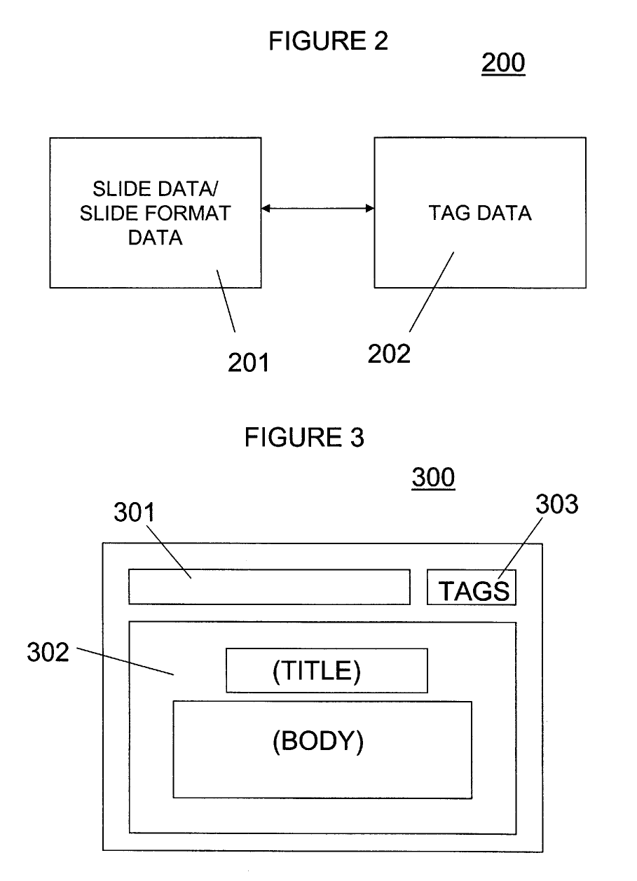

Thus, it can be seen from FIG. 2, the present invention provides a mechanism 200 such that each slide data 201 has an associated slide “tag” feature, and such tag feature can be a discrete tag field 202 distinct from the slide data 201 itself or can include access to the data within the data or format fields of the slide. It is specifically pointed out that the “tag” need not be a separate discrete field, since any one of the existing slide information content data, format data, or organization status of the slide within the overall presentation can impliedly serve as “tags” for purposes of servicing the functions of the present invention. Thus, as shown in step 101, a key aspect of the present invention is that each slide be associated with a “tag” feature that provides data available for various functions of slide management that are currently not incorporated in slide software programs.

In step 102, the method of the present invention includes a tag with various predetermined information (e.g., such as words in the slide title or slide body, format information such as slide categories or the presentation outline categories into which the slide is originally fitted) and/or enables the user to create new tags formats or data for the functions related to slide management. It should be noted that the “tag” is not necessarily a single tag, since any number of tags could be associated with a slide for purpose of slide management, possibly including, as non-limiting examples, different tags for different slide management functions, different types of information, different data fields, and so on.

As mentioned earlier, a tag might be predefined, perhaps because of an expected common usage, or it might be initiated and defined by user manual input, similar to the concept of a user-defined macro in a word processor, or could be extracted automatically from data in the information or format fields of the data for each slide or from the format and/or overall organization of the slide presentation.

If, for example, the slides had been arranged in a certain order by the presenter and a question arose during the presentation, the remainder of the presentation could be rearranged automatically by selecting and activating one or more tag criteria that would re-organize the slides in a new sequence more appropriate to the direction implied from the question. Moreover, it is noted that user-defined tags can be expressed in semantic (natural) language.

In method step 103, the slide managing mechanism of the present invention could also include various pre-set functions to exercise the tags and/or includes the capability of allowing the user to define new functions, again similar to the concept of user-defined macros currently available in such applications as conventional word processors. Non-limiting examples of pre-defined slide management functions would include sorting, filtering, and other related functions, including possibly functions related to automatically organizing and/or reorganizing the slides into a presentation sequence according to criteria defined by tag information.

These capabilities such as sorting would be useful, for example, in scenarios in which slides are originally arranged by the author in accordance with a hierarchy of ordering or classification and the presenter wishes to rearrange the ordering or hierarchy because of events during the presentation. The capabilities such as filtering would be useful, for example, when only a subset of the entire set of slides is relevant for a particular presentation.

A number of functions could be provided by a slide management program as taught by the present invention. As non-limiting examples, functions might include the sorting of the slides or the filtering of the slides in accordance with one or more criteria, and/or querying of the slides, including a concept similar to retrieval of matches of a user query search. As previously indicated, the functions might involve manipulation of data included in the information content of the slides themselves, the format data of each slide, or even some indication of the organization or classification of the slides in the organization of the original presentation.

The slide management feature is not intended as confined to a single criterion, but could have a hierarchy of criteria defined, similar to a definition of a macro or query that is well known in other arts, such that the user could define a plurality of criteria that defines a complex management scheme for the slides.

Finally, in step 104, the slide managing software method also includes a mechanism to operate the feature, including, for example, implementation of such mechanisms as drop-down menus for implementing one or more functions discussed above.

Thus, as exemplarily shown in FIG. 3, a software program directed toward generation and/or presentation of slides would typically include a canvas 300 that contains, in addition to tool bar menu items 301 related to generating or controlling the contents of the slide 302, at least one additional tool bar or menu item 303 providing the features and functions of the present invention, including those functions exemplarily discussed relative to FIG. 1. As previously mentioned, such tag features might be accessible through a graphical user interface (GUI) of the slide generation and/or presentation software program as additional toolbar entries 303 having a format of one or more drop down menus, although the details of the format to implement access to tags and management functions are not particularly significant.

It is also noted that, although FIG. 3 may imply that the present invention is performed from within a slide-reading or slide-generating program, such is not a requirement, since the method of the present invention could also be performed from outside the program. Such external implementation is intended as included in the concept of the present invention.

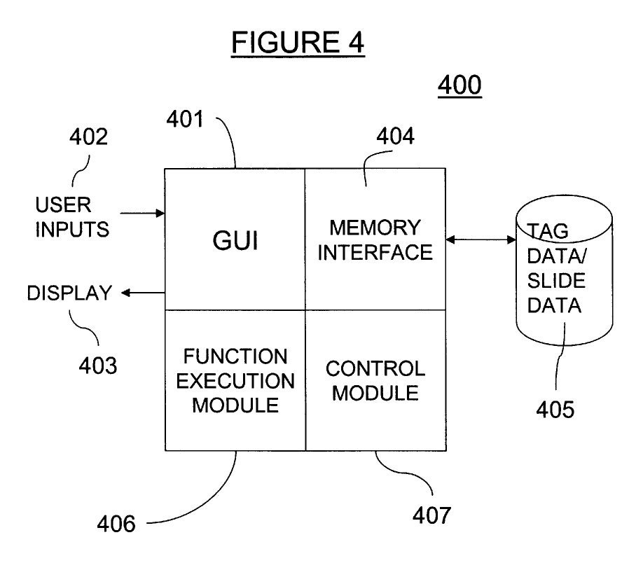

FIG. 4 shows one exemplary block diagram 400 for a software module that implements the concepts of the present invention and that could be easily incorporated into existing software slide generation/presentation programs. Graphical User Interface (GUI) 401 permits the user to provide inputs 402 and to receive display data 403 on, for example, a display screen. Memory interface 404 permits tag and slide data, as well as possibly function instructions, to move into and out of memory 405. Function execution module executes the functions as based on tag data, and control module 407 serves as the main function for the other modules.

### Exemplary Hardware Implementation

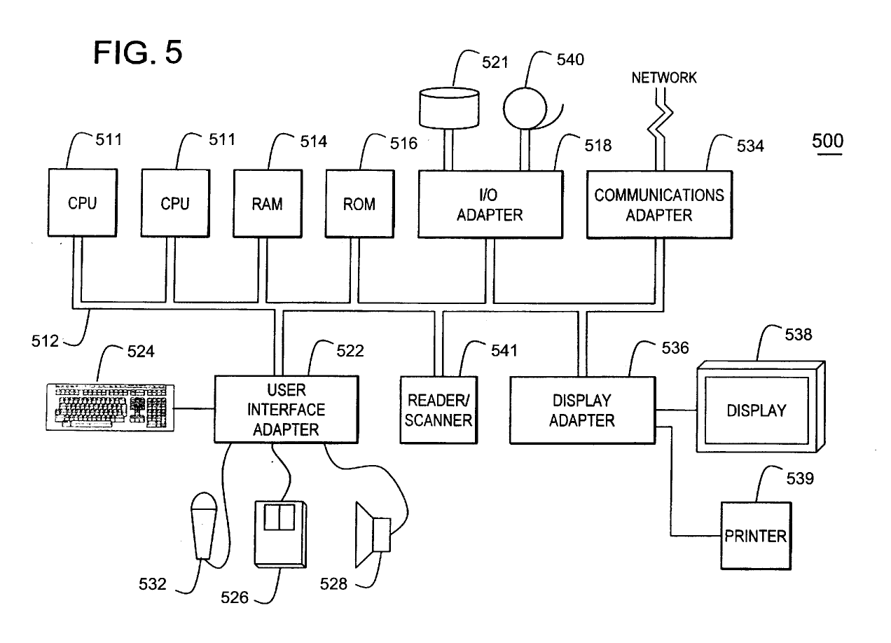

FIG. 5 illustrates a typical hardware configuration of an information handling/computer system in accordance with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer 539 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 511 and hardware above, to perform the method of the invention.

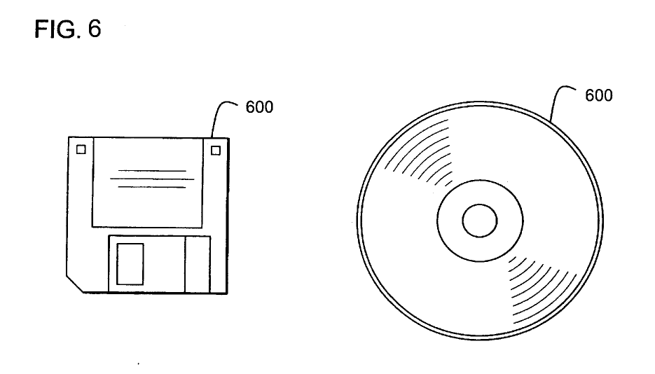

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 611.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of managing a software slide deck comprising a plurality of slides, said method comprising:
associating tag data for one or more of said slides in said slide deck for processing at least one function related to managing said slide deck.

2. The method of claim 1, wherein said tag data comprises at least one of:
information data from within a slide contents;
format data of a slide;
data related to an organization of a slide within a presentation; and
data entered by a user.

3. The method of claim 1, wherein said at least one function comprises at least one of:
sorting;
filtering; and
querying.

4. The method of claim 1, wherein said tag data comprises data that is at least one of:
manually entered by a user; and
extracted automatically from slide data.

5. The method of claim 1, wherein at least one of:
a tag format is pre-defined; and
a user can define a tag format.

6. The method of claim 1, wherein one or more tags are selectively associated with each slide.

7. The method of claim 1, wherein commonly-used predefined tags can be associated with a slide.

8. The method of claim 1, wherein user-defined tags can be expressed in a semantic (natural) language.

9. The method of claim 1, wherein at least one of said at least one function is executed outside of a slide presentation application program.

10. The method of claim 1, wherein at least one of said at least one function is executed inside of a slide presentation application program.

11. A system for managing a software slide deck comprising a plurality of slides, said system comprising:
a software module for associating tag data for one or more slides in said slide deck for processing at least one function related to managing said slide deck.

12. The system of claim 11, further comprising a software module executing said at least one function to process said tag data.

13. The system of claim 11, wherein said tag data comprises at least one of:
information data from within a slide contents;
format data of a slide;
data related to an organization of a slide within a presentation; and
data entered by a user.

14. The system of claim 11, wherein said at least one function comprises at least one of:
sorting;
filtering; and
querying.

15. The system of claim 11, further providing a graphical user interface (GUI) for user interactions related to said tag data and said at least one function.

16. The system of claim 11, wherein said tag data comprises data that is at least one of:
manually entered by a user through a graphical user interface (GUI); and
extracted automatically by an extraction module from data associated with each slide.

17. The system of claim 11, further comprising a macro function module wherein a user can define a function.

18. The system of claim 11, further comprising a slide-reading application program module for presenting slide data, and said at least one function related to managing said slide deck is executed outside of said slide-reading application program.

19. The system of claim 11, further comprising a slide-reading application program module for presenting slide data, and said at least one function related to managing said slide deck is executed from inside of said slide-reading application program.

20. A signal-bearing medium tangibly embodying a program of machine-readable instructions executable by a digital processing apparatus to perform the method of managing a software slide deck, as described in claim 1.
